(19) United States
(12) Patent Application Publication
(10) Pub. No.: US 2019/0055159 A1
(43) Pub. Date: Feb. 21, 2019

(54) USE OF FATTY ACID-MODIFIED RESINS TO CONFER ANTI-FINGERPRINT PROPERTY TO A GLASS SHEET

(71) Applicant: AGC GLASS EUROPE, Louvain-La-Neuve (BE)

(72) Inventors: Eric BOSGAERD, Ways (BE); Ronny PIETERS, Bousval (BE); Nicolas CLEMENT, Walhain (BE)

(73) Assignee: AGC GLASS EUROPE, Louvain-La-Neuve (BE)

(21) Appl. No.: 16/084,879

(22) PCT Filed: Mar. 13, 2017
(86) PCT No.: PCT/EP2017/055817

§ 371 Date: Sep. 13, 2018

(30) Foreign Application Priority Data
Mar. 16, 2016 (EP) 16160617.3

(51) Int. Cl. C03C 17/32; C09D 5/00; C09D 163/00; C09D 175/04; C09D 133/14

(52) U.S. Cl. CPC C03C 17/326; C03C 17/322; C03C 17/32; C09D 5/00; C03C 2218/116; C09D 175/04; C09D 133/14; C03C 2217/70; C09D 163/00

(57) ABSTRACT

The invention relates to the use of a coating comprising at least one fatty-acid modified resin as an anti-fingerprint coating on a least one face of a glass sheet. In particular, the invention allows to provide an anti-fingerprint solution to be used for a glass sheet, which does not significantly affect the surface properties and the aesthetics of the coated glass compared to the naked glass. Moreover, the invention allows to provide an anti-fingerprint solution to be used for a glass sheet, which is sustainable in time and/or wearing of the surface.

### 1. FIELD OF THE INVENTION

The present invention relates to the use of a coating comprising a fatty acid-modified resin as a coating conferring anti-fingerprint property to a glass sheet.

These last years, electronic devices with touch functionalities like smartphones, TV, computers, digital cameras, household appliances, . . . have undergone a huge and quick development on the market. Therefore, smart surfaces/covers for touch applications are increasingly in demand, with a desired broad range of aesthetic and technological properties, one of the most important being the anti-fingerprint property. Contamination caused by fingerprints is indeed a major issue for touch devices, but this is also the case in a general manner for non-electronic building, automotive glazings, or decorative materials (for example, wall covers, mirrors, tables, shelves, . . . ).

When the surface/cover exposed to fingers is made of transparent or semi-transparent glass, fingerprint smudging is clearly visible and causes unfortunately an aesthetical deterioration in the general appearance of the product. Accordingly, there is a demand of the market for resolving the problem of the fingerprint contamination on the surface of glass in general, this demand being of course more and more pressing from the display market because of the development of touchscreen interface technology of electronic devices.

Generally speaking, an anti-fingerprint surface must, on one hand, avoid or limit transfer of both water and oil when touched by a finger of a user and, on the other hand, limit the visibility of transferred material. The wetting characteristics of such a surface are such that the surface need to be both hydrophobic and oleophilic.

### 2. SOLUTIONS OF THE PRIOR ART

The general understanding of anti-fingerprint property covers in fact two different properties. On the one hand, the actual anti-fingerprint property, which is the ability to have as much as possible invisible or nearly invisible fingerprints on a substrate. On the other hand, the easy-to-clean property, which is the ability to easily wipe off fingerprints from the substrate. However, in common language, easy-to-clean is often associated to anti-fingerprint while it covers actually another property.

Known anti-fingerprint solutions for different kinds of surface (metal, glass, plastics, . . . ) are based essentially on two paths:

(i) reducing/avoiding transfer of fingerprint on the surface: sweat or/and grease from fingers of a user is not liable to be adhered to the surface. The fingerprint from the user is thus prevented from being imprinted and the surface can remain clean and aesthetically pleasing;

(ii) decomposing chemical substances from the fingerprint: meaning a kind of self-cleaning function;

(iii) masking of fingerprint on the surface where it is transferred.

The major part of the proposed solutions in the art are mainly in the form of a coating deposited, in a more or less thickness, on the surface to render resistant to fingerprint smudging. Some other corresponds to a chemical/physical treatment of the surface itself.

Recent examples in the art of an anti-fingerprint solution based on decomposing chemical substances from the fingerprint is given by US2012/177913A1 or US2012/0219782A1, which propose the use of a lipolytic enzyme for forming anti-fingerprint coating. The lipolytic enzyme includes any enzymes having a characteristic of hydrolyzing lipid components from fingerprints such as triglycerides, wax monoesters, squalenes, . . . . Such a solution is however not straightforward to implement industrially on a large scale and on large surfaces and moreover, the sustainability/lasting quality of the “self-cleaning” property is uncertain with time and wearing of the surface.

One recent example in the art of an anti-fingerprint solution based on reducing/avoiding transfer of fingerprint on the surface is given by US2012/0251706A1, which proposes a method of manufacturing an anti-fingerprint paint. This method comprises the following steps: (i) blend of fluorinated polymer with fluorocarbon solvents to form fluorocarbon polymer paint; (ii) blend nano-particles with the fluorocarbon solvents, then add the fluorine-couplant into the fluorocarbon solvents with the nano-particles therein, and further mix up the above-mentioned solvents to get a nano-particle solvent with an outside surface of each of the nano-particles dressed up by a layer of fluorinated molecules; and (iii) blend the fluorocarbon polymer paint with the nano-particle solvents and further mix up the mixture of the fluorocarbon polymer paint and the nano-particle solvents to form the anti-fingerprint paint. Such a paint may then be deposited on a substrate like glass or metal for example. However, such a solution requires a tedious process including several steps to obtain the final anti-fingerprint surface.

Next to that, US2013/0157008 A1 describes an article including a substrate and a nanostructured layer bonded to the substrate. The nanostructured layer can include a plurality of spaced apart nanostructured features comprising a contiguous, protrusive material and the nanostructured features can be sufficiently small that the nanostructured layer is optically transparent. A continuous layer can be adhered to a plurality of surfaces of the nanostructured features to render the plurality of surfaces of the nanostructured features both hydrophobic and oleophobic with respect to fingerprint secretions, thereby providing an anti-fingerprinting characteristic to the article. However, such a solution gives a substrate with a significantly modified surface in term of touch, the final surface being not perfectly smooth.

One recent example in the art of surface treatment of a glass substrate to give an anti-fingerprint property is given by US2010/0282275A1 which proposes a substrate bearing topological features that provides hydrophobic and oleophobic properties to its surface. These particular surface features together have a re-entrant geometry that prevents a decrease in contact angle and pinning of drops comprising water and sebaceous oil. However, again, such a solution gives a substrate with a final surface being not perfectly smooth and with a touch feeling very different from initial substrate. Moreover, in the case of a transparent substrate like glass, such topological features will also affect the aesthetics/optical properties of the treated glass (transparency, colour, etc) compared to the initial glass.

### 3. OBJECTIVES OF THE INVENTION

The objective of the invention is to provide an anti-fingerprint solution to be used for glass substrates, which solves the cited disadvantages and resolving the technical problem posed. In particular, an objective of the invention in at least one of its embodiments is to provide an anti-fingerprint solution to be used for glass substrates.

Another objective of the invention in at least one of its embodiments is to provide an anti-fingerprint solution to be used for glass substrates, which does not significantly affect the surface properties (scratching resistance, chemical durability, . . . ) and touch feeling of the treated glass substrate product compared to the initial glass substrate.

Another objective of the invention in at least one of its embodiments is to provide an anti-fingerprint solution to be used for glass substrates, which does not significantly affect the aesthetics of the treated glass substrate product compared to the initial glass substrate.

Another objective of the invention in at least one of its embodiments is to provide an anti-fingerprint solution to be used for glass substrates, for which the anti-fingerprint property is sustainable in time and/or wearing of the surface.

Yet another objective of the invention in at least one its embodiments is to provide an anti-fingerprint solution allowing to avoid any action such as wiping off to reduce the visibility of the fingerprint.

Still another objective of the invention in at least one of its embodiments is to provide an anti-fingerprint solution to be used for glass substrates, which is economical and simple and quick to produce industrially.

### 4. OUTLINE OF THE INVENTION

The invention relates to the use of a coating comprising at least one fatty acid-modified resin as an anti-fingerprint coating on a least one face of a glass sheet.

Hence, the invention rests on a novel and inventive approach, since it enables a solution to be found for the disadvantages of prior art. In particular, the inventors have found that by selecting this specific type of resins, currently available, and using it in a coating for a glass sheet, it is possible to confer to the substrate an anti-fingerprint property compared to the naked substrate, while keeping as much as possible its initial surface properties and also, its aesthetical/optical properties.

Throughout the present text, when a range is indicated, the extremities are included. In addition, all the integral and subdomain values in the numerical range are expressly included as if explicitly written.

Other features and advantages of the invention will be made clearer from reading the following description of preferred embodiments given by way of simple illustrative and non-restrictive examples.

The present invention relates to the anti-fingerprint property that is different from the easy-to-clean property.

By “anti-fingerprint property”, in the present description, it is meant(i) the resistance of a surface to the transfer of components found in human fingerprints; (ii) the minimization, hiding, or obscuring of human fingerprints on a surface, and (iii) combinations thereof. “Fingerprint components” include sebaceous oils (e.g. secreted skin oils, fats, and waxes), debris of dead fat-producing cells, aqueous components, etc, and their mixtures.

The anti-fingerprint property allows advantageously to avoid any action to reduce the visibility of the fingerprint such as the wiping off action associated with the easy-to-clean approach.

The anti-fingerprint property of a glass sheet according to the invention may be evaluated through the following method with the following consecutive steps:

(i) Fingerprint Deposition:

Two fingerprint deposition methods may be used, for fingerprint marking on coated glass sheets and uncoated glass sheet (reference):
an “artificial deposition” consisting on the deposition of a given amount of an artificial sebum solution on a pad (rubber piece on which a fingerprint is engraved in 3 dimensions, mounted on a stamp allowing a reproducible application); and
a “natural deposition” consisting in deposition of a real fingerprint by contacting a finger bestriding two samples (one coated sample and its reference without coating) with a constant and reproducible load.

(ii) Fingerprint Evaluation:

First, pictures are taken under controlled conditions, in a “black box” (i.e. a black-painted wooden box) with “front lights” and a “top light”, allowing three lightning conditions:
“Front light condition”, with the pair of front lights close to the camera (top light is switched off);
“Grazing light condition”, with the top light just above the sample (front lights are switched off);
“Back light condition”, with the top light in the back section (front lights are switched off).

Then, fingerprint visibility is evaluated through comparison of the imprinted fingerprints on the evaluated samples and reference, using pictures taken in the same lighting conditions. The following quotation system was used:

| Observation/comparison, in term | |
|---|---|
| of anti-fingerprint property | Quotation |
| Worse than reference* | −1 |
| Equal to reference* | 0 |
| slightly better than reference* | +1 |
| Significantly better than reference* | +2 |
| No fingerprint visible on sample | +3 |

*Reference is the same glass sheet but without the coating (uncoated glass sheet).

The anti-fingerprint property according to the invention may have a certain kinetics (some short delay to observe the anti-fingerprint effect, i.e. one hour) but it is preferably not desired. In such an event, the evaluation of the anti-fingerprint property is done when equilibrium is reached.

An anti-fingerprint property is thus observed when quotation is from +1. Preferably, the invention allows to reach a quotation of at least +2.

According to the invention, the substrate bearing the coating is a glass sheet. According to an embodiment, the glass sheet is a float glass sheet. The term “float glass sheet” is understood to mean a glass sheet formed by the float method, which consists in pouring the molten glass onto a bath of molten tin, under reducing conditions. A float glass sheet comprises, in a known way, a “tin face”, that is to say a face enriched in tin in the body of the glass close to the surface of the sheet. The term “enrichment in tin” is understood to mean an increase in the concentration of tin with respect to the composition of the glass at the core, which may or may not be substantially zero (devoid of tin). Therefore, a float glass sheet can be easily distinguished from sheets obtained by other glassmaking methods, in particular by the tin oxide content which may be measured, for example, by electronic microprobe to a depth of ˜10 microns. In many cases and as illustration, this content lies between 1 and 5 wt %, integrated over the first 10 microns starting from the surface.

Alternatively, according to another embodiment, the glass sheet is a cast or drawn glass sheet.

The glass sheet according to the invention is made of glass whose matrix composition is not particularly limited and may thus belong to different categories. The glass may be a soda-lime-silicate glass, an alumino-silicate glass, an alkali-free glass, a boro-silicate glass, etc. It may be a clear, extra-clear/low-iron or coloured glass sheet. Preferably, the glass sheet of the invention is made of a soda-lime glass or an alumino-silicate glass. Non-limiting examples of glass sheets are Planibel® Clear, Linea Azzura®, Dragontrail®.

The glass sheet of the invention can be of any desired dimensions, such as length, width, shape and/or thickness. In one embodiment, the glass sheet of the invention may have a thickness of from 0.1 to 25 mm. Advantageously, in the case of display applications, the glass sheet has preferably a thickness of from 0.1 to 6 mm. More preferably, in the case of display applications and for reasons of weight, the thickness of the glass sheet is of from 0.1 to 2.2 mm. The glass sheet according to the invention may be flat or curved/bended.

The glass sheet of the invention may be textured/patterned, on both faces or alternatively, on one of its face, either the face bearing the coating according to the invention or the face opposite to that bearing the coating according to the invention.

According to the applications, intended use and/or properties desired, various layer(s)/treatment(s) can be deposited/done on the glass sheet of the invention, in particular on the face opposite to that bearing the coating of the invention. In particular, the glass sheet of the invention may be covered on the face opposite to that bearing the coating of the invention by a paint/enamel layer (i.e. Lacobel® product from AGC Glass Europe) or by a mirror stack (Ag layer, paint(s)).

The glass sheet according to the invention can advantageously be chemically or thermally tempered, in order to increase its mechanical resistance. It may also be laminated, for example with a layer of PVB or EVA from the side opposite to that bearing the coating of the invention (to another glass sheet or not).

The coating of the invention covers at least one face of the glass sheet. According to the invention, the coating may extend continuously over substantially the whole surface of said face of the glass sheet, e.g. over more than 90% of the surface, preferably over more than 95% of the surface. Alternatively, the coating may cover partially the at least one face of the glass sheet.

According to an embodiment, the coating of the invention covers both faces of the glass sheet.

According to the invention, once dried and/or cross-linked, the coating may have a thickness (dry thickness film or DTF) in the range of between 0.2 and 150 microns. Preferably, the coating may have a thickness in the range of between 0.2-100 microns, or even 0.2-80 microns. Decreasing the upper range of the thickness has the advantage to allow easier curing/drying, while not affecting the anti-fingerprint effect. More preferably, the coating may have a thickness in the range of between 0.5-100 microns, or even 1-100 microns. Increasing the lower range of the thickness has the advantage to have coating more mechanically resistant. Such thicknesses may be reached, during the manufacturing process, by one or more coating applications. References to coating thicknesses herein are references to the mean geometrical thickness of the coating.

In an advantageous embodiment, an adhesion promoter is present between the glass sheet and the coating, to further improve the adhesion of the coating to the glass sheet. The adhesion promoter agent may contain a silane, for example.

Preferably, the coating of the invention is in direct contact with the glass sheet. In such an embodiment, the glass sheet can however be chemically treated prior to be covered by the coating, without departing from this embodiment (for example, with an adhesion promoter like a silane, which can thus be found between the glass sheet and said coating).

According to the invention, the coating comprises at least a fatty-acid modified resin. By “fatty acid-modified resin” (also often called “oil-modified resin or polymers”), it is meant a resin which has been structurally modified by grafted fatty acid functions (end groups). According to the invention, by “fatty acid function”, it is meant a carboxylate ester function with a long alkyl chain, which is either saturated or mono or poly unsaturated, conjugated or not, branched or not. A wide range of fatty acids can be used in the fatty acid-modified resin according to the invention. Essentially, the fatty acid-modified resin usable in the present invention is essentially any of the conventional or currently available fatty acid-modified resins (or any fatty acid-modified resin which may be produced in the future).

For example, the hydrocarbon chain length of the grafted fatty acid functions may vary from 4 to 36, or even from 10 to 30 carbons. Preferably, the hydrocarbon chain length of the grafted fatty acid functions varies from 12 to 18. The grafted fatty acid functions can be either saturated or unsaturated, and/or branched or not.

Fatty acid-modified resins are well known in the art of paints and clearcoats. They are mainly advantageous because of their lower solvent requirement for attaining a coating viscosity (“green” aspect) and their better cure response compared to the corresponding non-grafted resin (giving “fast drying paint”).

According to the invention, the resin from the at least a fatty acid-modified resin may be a polyol, polyurethane, polyester, polyacrylic, polyacrylate, polymethacrylate, acrylamide, melamine, polycarbonate, acrylic-styrene, vinyl-acrylic, polyolefine, polyurea, polyamide, epoxy epoxy ester, epoxy acrylate, phenolic, amino, PVC, or PVB. Particularly good results were obtained with a resin polyurethane.

Examples of fatty acid-modified resins are disclosed in U.S. Pat. No. 5,039,740 and U.S. Pat. No. 4,144,871. Other examples of commercially available fatty acid-modified resins are Bayhydrol® UH2593/1 from Bayer (Aliphatic, fatty acid-modified, anionic polyurethane dispersion) and Macrynal® VSM2521w from Allnex (fatty acid-modified, acrylic polyol dispersion).

Preferably, the coating, once dried and/or cross-linked, comprises from 15% to 100% by weight of the fatty acid-modified resin. More preferably, the coating comprises from 50% to 100% by weight of the fatty acid-modified resin. The % by weight of the fatty acid modified resin must here be understood as the % by weight of fatty acid modified resin present in the coating as free species and/or as incorporated in the crosslinked network. In a very preferred embodiment, the coating consists essentially of the fatty acid-modified resin.

Preferably also, the coating, once dried and/or cross-linked, comprises from 0.05 to 10% by weight of fatty acid functions.

According to the invention, the coating may comprise a mixture of different fatty acid-modified resins, i.e. different in term of the resin and/or in term of the nature of the grafted fatty acid functions.

According to the invention, additionally to the fatty-acid modified resin, the coating may comprise other components like, for example, monomers, oligomers, photo-initiators, or additives such as dispersing agent, leveling agent, pigments/colorants, flowing agent, anti-UV agent, catalysts, coalescent agent, wetting agent/surfactant, adhesion promoter, and/or matting agent.

The fatty acid function in the resin may be evidenced in the coating of the invention in an appropriate manner, for example, by characterization by the ToF-SIMS technique. Hence, for example, the following fatty acid functions can be found in the ToF-SIMS results when analysing the cured coating (after having scraped it from the glass sheet): lauric (fragment C12H23O2); myristic (fragment C14H27O2); palmitic (fragment C16H31O2); oleic (fragment C18H33O2); stearic (fragment C18H35O2).

According to the invention, the coated glass sheet is obtained by means of a process comprising the following steps in order (or substantially concomitant):
(a) depositing the coating onto the glass sheet; and
(b) drying and/or cross-linking the coating.

Different methods known per se can be suitable for depositing the coating onto the glass sheet. For example, it can be deposited by one of the following deposition methods: bar coating, spin coating, dip coating, spraying (i.e. LP pulverization, HVLP pulverization, airless pulverization or combined spraying technologies like Airmix®, DUO®, . . . ), ultrasonic pulverization, electrospray pulverization, curtain coating, roller coating, slid coating, flow coating.

After the step of depositing, the coating is then dried and/or cross-linked/cured, e.g. by means of heat and/or by means of UV or IR rays. This step allows the coating to dry, harden and adhere to the glass sheet.

Embodiments of the invention will now be further described, by way of examples only, together with some comparative examples, not in accordance with the invention. The following examples are provided for illustrative purposes, and are not intended to limit the scope of this invention.

### EXAMPLES

### 1) Preparation

### a) Examples 1-12

Coating Preparation:

(a) g of a commercially available fatty-acid modified resin from Sartomer Company (reference CN116: fatty acid modified bisphenol A epoxy acrylate; or reference CN113D70: fatty acid modified trifunctional epoxy acrylate) was diluted with (b) g of a SR9020 dilutant from Sartomer Company.

(c) g 2-Hydroxy-2-methylpropiophenone (photo-initiator) and (d) g of Silquest A189 (silane) were then successively added.

The mixture was then gently mixed to avoid any air bubble incorporation.

Coating Deposition:

A glass sheet, consisting of a 100×100 mm soda-lime clear glass plate (Planibel® clear, thickness: 4 mm) was cleaned classically with a washing machine using alkaline detergent. Quickly after cleaning, the application of the coating previously prepared was done on the cooled down glass sheet using a spin coater (amount: 1.5 g, rotation speed: 8000 rpm, acceleration: 2500 rpm-1, duration: 30 sec.). The UV reticulation of the coating was then performed using a UV curing system Nathgraph UV Cure-365 nm-30 minutes.

Such an application gives a dry thickness film (DTF) of (e) μm.

Table 1 presents experimental (a) to (e) values for examples 1-12.

TABLE 1

| | Commercial liquid | (a) | (b) | (c) | (d) | (e) |
|---|---|---|---|---|---|---|
| EX. | epoxy acrylate used | [g] | [g] | [g] | [g] | [microns] |
| 1 | CN116 | 49 | 0 | 4 | 0.2 | 34 |
| 2 | CN116 | 48 | 0 | 8 | 0.2 | 28 |
| 3 | CN116 | 24 | 0 | 16 | 0.1 | 26 |
| 4 | CN116 | 20.25 | 3.75 | 16 | 0.1 | 36 |
| 5 | CN116 | 16.5 | 7.5 | 16 | 0.1 | 7.5 |
| 6 | CN116 | 12.75 | 11.25 | 16 | 0.1 | 4 |
| 7 | CN113D70 | 49 | 0 | 4 | 0.2 | 27 |
| 8 | CN113D70 | 48 | 0 | 8 | 0.2 | 21 |
| 9 | CN113D70 | 24 | 0 | 16 | 0.1 | 19 |
| 10 | CN113D70 | 20.25 | 3.75 | 16 | 0.1 | 22 |
| 11 | CN113D70 | 16.5 | 7.5 | 16 | 0.1 | 28 |
| 12 | CN113D70 | 12.75 | 11.25 | 16 | 0.1 | 21 |

### b) Example 13

Coating Preparation:

A solution (A) was prepared by mixing the following components, at room temperature under gentle mixing:

| | |
|---|---|
| Bayhydrol UH 2593/1 from Bayer Company (an aliphatic, | 26.47 g |
| fatty acid-modified, anionic polyurethane dispersion): | |
| Butyl diglycol (CAS 112-34-5, solvent): | 1.39 g |
| BYK 346 (surfactant): | 0.12 g |
| Deionized water: | 1.46 g |

A solution (B) was prepared by mixing the following components, at room temperature under gentle mixing:

| | |
|---|---|
| Dipropylene glycol (CAS 25265-71-8, solvent): | 0.49 g |
| Silquest A189: | 0.06 g |

Just before coating deposition, solution (A) and solution (B) were gently mixed together.

Coating Deposition:

A glass sheet, consisting of a 100×100 mm soda-lime clear glass plate (Planibel® clear, thickness: 4 mm) was cleaned classically with a washing machine using alkaline detergent. Quickly after cleaning, the application of the coating previously prepared was done on the cooled down glass substrate using a spin coater (amount: 1.5 g, rotation speed: 8000 rpm, acceleration: 2500 rpm-1, duration: 30 sec.). Sample was thermally dried using IR lamps furnace at 130° for 5 minutes. Such an application gives a dry thickness film (DTF) of 10 μm.

### Examples 14-16

Coating Preparation:

The following commercially available resins were used in those examples:
Macrynal VSM2521 (Allnex Company): a fatty acid modified water-based acrylic resin;
Bayhydrol UH 2593/1 (Bayer Company): an aliphatic, fatty acid-modified, anionic polyurethane dispersion;
Daotan TW7000 (Allnex Company): a polyurethane resin;
Resydrol AY 5537W (Allnex Company): a water-based polyester/acrylate resin.

Coating for examples 14-16 were prepared following Table 2 below.

TABLE 2

| | Daotan | Macrynal | Bayhydrol | Resydrol | Silquest |
|---|---|---|---|---|---|
| | TW7000 | 2521 | UH 2593/1 | AY 5537W | A189 |
| EX. | [g] | [g] | [g] | [g] | [g] |
| 14 | 24.95 | 24.95 | — | — | 0.10 |
| 15 | 12.50 | 12.50 | 24.90 | — | 0.10 |
| 16 | — | 24.95 | — | 24.95 | 0.10 |

Coating Deposition:

A glass sheet, consisting of a 100×100 mm soda-lime clear glass plate (Planibel® clear, thickness: 4 mm) was cleaned classically with a washing machine using alkaline detergent. Quickly after cleaning, the application of the coating previously prepared was done on the cooled down glass substrate using a spin coater (amount: 1.5 g, rotation speed: 8000 rpm, acceleration: 2500 rpm-1, duration: 30 sec.). Samples are thermally dried using IR lamps furnace at 130° for 5 minutes. Such an application gives a dry thickness film (DTF) of 8.5, 2.4 and 5.5 μm respectively for examples 14, 15 and 16. from 1 to 20 μm.

### c) Example 17

The following commercially available fatty-acid modified resin was used in this example: Neorad E-20 from DSM Company (a fatty acid modified bisphenol A epoxy acrylate).

Coating Deposition:

A glass sheet, consisting of a 100×100 mm soda-lime clear glass plate (Planibel® clear, thickness: 4 mm) was cleaned classically with a washing machine using alkaline detergent. Quickly after cleaning, the application of the coating previously prepared was done on the cooled down glass substrate using a spin coater (amount: 1.5 g, rotation speed: 8000 rpm, acceleration: 2500 rpm-1, duration: 30 sec.). Samples are thermally dried using IR lamps furnace at 130° for 5 minutes. Such an application gives a dry thickness film (DTF) of 10 μm.

### d) Examples 18-19 (Comparative)

The following commercially available resins from Allnex Company were used in those examples (those resins are not modified with fatty-acid functions):
Daotan TW7000: a polyurethane resin;
Resydrol AY 5537W: a water-based polyester/acrylate resin.

Coating for examples 18-19 were prepared following Table 3 below.

TABLE 3

| | Daotan | Silquest | Resydrol |
|---|---|---|---|
| EX. | TW7000 | A189 | AY 5537W |
| 18 | 49.90 | 0.10 | |
| 19 | | 0.10 | 49.90 |

Coating Deposition:

A glass sheet, consisting of a 100×100 mm soda-lime clear glass plate (Planibel® clear, thickness: 4 mm) was cleaned classically with a washing machine using alkaline detergent. Quickly after cleaning, the application of the coating previously prepared was done on the cooled down glass substrate using a spin coater (amount: 1.5 g, rotation speed: 8000 rpm, acceleration: 2500 rpm-1, duration: 30 sec.). Samples are thermally dried using IR lamps furnace at 130° for 5 minutes. Such an application gives a dry thickness film (DTF) of 5.9 and 6.9 μm respectively for examples 18 and 19 from 1 to 20 μm.

### 2) Anti-Fingerprint Property Evaluation

Anti-fingerprint property of each of examples 1-19 was assessed as follows:

(i) Fingerprint deposition by “natural deposition”: deposition of a real fingerprint by contacting a finger bestriding two samples (the coated sample and its reference without coating) with a constant and reproducible load.

(ii) Fingerprint evaluation: Pictures of the imprinted samples were all taken in a “black box” (black-painted wooden box) with a “front light condition” (pair of lights close to the camera)

Evaluation of the visibility of the imprinted fingerprints on the samples and their reference was performed on the pictures, using the quotation system exposed above.

Results of this anti-fingerprint evaluation for each examples are given in Table 4.

This table shows that use of fatty acid-modified resins in a coating according to the invention well allows to get a significant anti-fingerprint property, especially when compared to the corresponding naked glass sheet (reference is quotation 0) and compared to a glass sheet covered with a coating of resin not modified by fatty-acid (comparative examples 18-19, with a quotation 0).

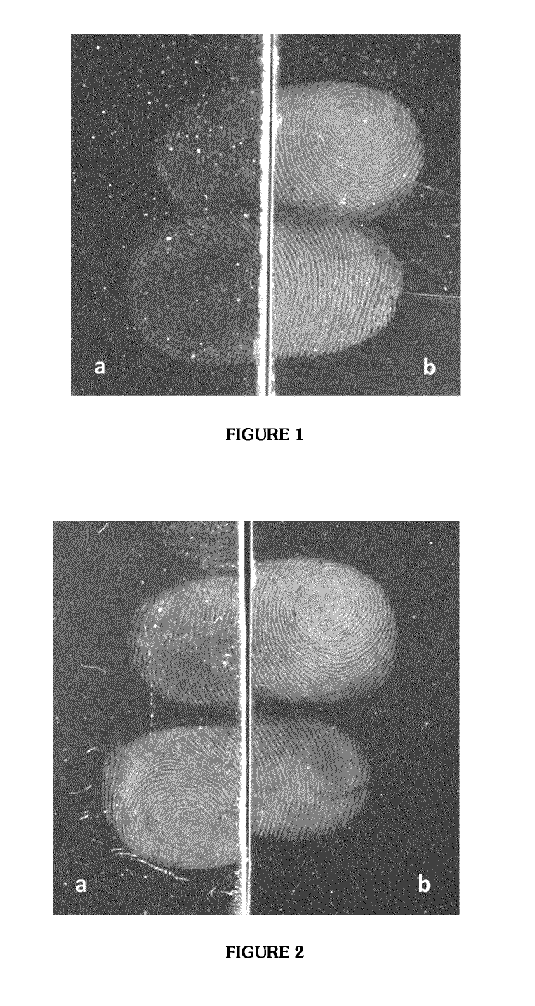

The anti-fingerprint property given by the invention is illustrated in FIG. 1, showing the picture taken for evaluation example 1. FIG. 2 illustrates anti-fingerprint property of example 18 (resin not modified by fatty-acid. For each of FIGS. 1 and 2, left part (a) of the picture represents coated sheet and right part (b) represents corresponding uncoated sheet acting as a reference.

TABLE 4

| EX. | Quotation |
|---|---|
| 1 | +2 |
| 2 | +2 |
| 3 | +2 |
| 4 | +2 |
| 5 | +2 |
| 6 | +2 |
| 7 | +2 |
| 8 | +2 |
| 9 | +2 |
| 10 | +2 |
| 11 | +2 |
| 12 | +2 |
| 13 | +2 |
| 14 | +2 |
| 15 | +2 |
| 16 | +2 |
| 17 | +2 |
| 18 (comp) | 0 |
| 19 (comp) | 0 |

1. A coating comprising at least one fatty acid-modified resin, wherein:
the coating is arranged as an anti-fingerprint coating on at least one face of a glass sheet, and
said fatty acid modified resin is a resin which has been structurally modified by grafted fatty acid functional groups, wherein said fatty acid functional groups are carboxylate ester functional groups with a long alkyl chain, which is either saturated or mono or poly unsaturated, conjugated or not, branched or not.

2. The coating according to claim 1, wherein the coating, once dried and/or cross-linked, comprises from 15% to 100% by weight of the fatty acid-modified resin.

3. The coating according to claim 2, wherein the coating, once dried and/or cross-linked, comprises from 50% to 100% by weight of the fatty acid-modified resin.

4. The coating according to claim 1,
wherein the resin from the at least one fatty acid-modified resin is a polyol, polyurethane, polyester, polyacrylic, polyacrylate, polymethacrylate, acrylamide, melamine, polycarbonate, acrylic-styrene, vinyl-acrylic, polyolefine, polyurea, polyamide, epoxy, epoxy ester, epoxy acrylate, phenolic, amino, PVC, or PVB.

5. A coated glass sheet, comprising the coating according to claim 1 arranged on at least one face of the glass sheet.

6. The coated glass sheet according to claim 5, wherein the coating, once dried and/or cross-linked, comprises from 15% to 100% by weight of the fatty acid-modified resin.

7. The coated glass sheet according to claim 6, wherein the coating, once dried and/or cross-linked, comprises from 50% to 100% by weight of the fatty acid-modified resin.

8. The coated glass sheet according to claim 5,
wherein the resin from the at least one fatty acid-modified resin is a polyol, polyurethane, polyester, polyacrylic, polyacrylate, polymethacrylate, acrylamide, melamine, polycarbonate, acrylic-styrene, vinyl-acrylic, polyolefine, polyurea, polyamide, epoxy, epoxy ester, epoxy acrylate, phenolic, amino, PVC, or PVB.

9. A method, comprising applying a coating to at least one face of a glass sheet, wherein:
the coating comprises at least one fatty-acid modified resin,
said fatty acid modified resin is a resin which has been structurally modified by grafted fatty acid functional groups, and
said fatty acid functional groups are carboxylate ester functional groups with a long alkyl chain, which is either saturated or mono or poly unsaturated, conjugated or not, branched or not.

10. The method according to claim 9, wherein the coating, once dried and/or cross-linked, comprises from 15% to 100% by weight of the fatty acid-modified resin.

11. The method according to claim 10, wherein the coating, once dried and/or cross-linked, comprises from 50% to 100% by weight of the fatty acid-modified resin.

12. The method according to claim 9,
wherein the resin from the at least one fatty acid-modified resin is a polyol, polyurethane, polyester, polyacrylic, polyacrylate, polymethacrylate, acrylamide, melamine, polycarbonate, acrylic-styrene, vinyl-acrylic, polyolefine, polyurea, polyamide, epoxy, epoxy ester, epoxy acrylate, phenolic, amino, PVC, or PVB.
